(19) United States
(12) Patent Application Publication
(10) Pub. No.: US 2022/0410654 A1
(43) Pub. Date: Dec. 29, 2022

(54) APPARATUS AND METHOD FOR CONTROLLING ELECTRICAL LOADS OF VEHICLE

(71) Applicants: HYUNDAI MOTOR COMPANY, Seoul (KR); Kia Corporation, Seoul (KR)

(72) Inventor: Mun Soon KWON, Yongin-si (KR)

(73) Assignees: HYUNDAI MOTOR COMPANY, Seoul (KR); Kia Corporation, Seoul (KR)

(21) Appl. No.: 17/590,495

(22) Filed: Feb. 1, 2022

(30) Foreign Application Priority Data
Jun. 23, 2021 (KR) 10-2021-0081750

(51) Int. Cl. B60H 1/00; B60L 1/12

(52) U.S. Cl. CPC B60H 1/00278; B60L 1/12; B60H 1/00385

(57) ABSTRACT

Disclosed are an apparatus and a method for controlling electrical loads of a vehicle. The apparatus may include a high-voltage load that receives a high voltage from a high-voltage battery to perform an operation thereof, a low-voltage load that receives a low voltage from a low-voltage battery to perform an operation thereof, and a controller that mutually organically controls an output of the high-voltage load and an output of the low-voltage load based on a control level set by a user.

### CROSS-REFERENCE TO RELATED APPLICATION

This application is based on and claims the benefit of priority to Korean Patent Application No. 10-2021-0081750, filed on Jun. 23, 2021, with the Korean Intellectual Property Office, the entire disclosure of which is incorporated herein by reference.

### TECHNICAL FIELD

The present disclosure relates to a technology of efficiently controlling an output of a high-voltage load and an output of a low-voltage load provided in an electrical vehicle.

### BACKGROUND

In general, electric vehicles are environment-friendly vehicles that obtain power by using high-voltage batteries to drive electric motors. Examples of electric vehicles include hybrid electric vehicles (HEVs), electric vehicles (EVs), plug-in hybrid electric vehicles (PHEVs), and fuel cell electric vehicles (FCEVs).

An electric vehicle includes a high-voltage battery for supplying electric power to a high-voltage load, and an auxiliary battery for supplying electric power to a low-voltage load. Then, the high-voltage load may include an air conditioning device provided in the electric vehicle, and the low-voltage load may include a seat heating wire, a seat blower, and an infrared ray warmer provided in the electric vehicle.

Here, the air conditioning device may include a heater that increases a temperature of air and discharges the heated air into an interior of the electric vehicle and an air conditioner that decreases a temperature of air and discharges the cold air into the interior of the electric vehicle. The seat heating wire is a heating wire located in a seat cushion and a seatback and may directly transfer heat to hips and the back of a user. The seat blower is a blower located in the seat cushion and may directly transfer cold air to the hips and the back of the user.

A controller (for example, a heater controller) that controls an output of a high-voltage load provided in the electric vehicle and a controller (for example, a seat heating wire controller) that controls an output of a low-voltage load are operated independently. That is, the heater controller controls the heater based on a temperature set through an on/off operation of a heater switch by the user, and the seat heating wire controller controls the seat heating wire based on an on/off operation of the seat heating wire switch by the user.

The output of the high-voltage load and the output of the low-voltage load cannot be mutually organically controlled because the high-voltage load controller and the low-voltage load controller cannot cooperate with each other, and thus it may be impossible to increase an allowable travel distance of the electric vehicle while satisfying a requirement (an increase in a sensible temperature) of the user.

Accordingly, a measure of mutually organically controlling the output of the high-voltage load and the output of the low-voltage load is required.

The items described in the background art are written to enhance understanding of the background of the present disclosure, and may include items that have not been known to an ordinary person skilled in the art to which the present disclosure pertains.

### SUMMARY

The present disclosure addresses the above-mentioned problems occurring in the prior art while maintaining advantages achieved by the prior art.

An aspect of the present disclosure provides an apparatus and a method for controlling electrical loads of a vehicle. For example, an allowable travel distance of an electric vehicle may be increased while a requirement (an increase in a sensible temperature) of a user is satisfied, by mutually organically controlling an output of a high-voltage load provided in the electric vehicle and an output of a low-voltage load.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for controlling electrical loads of a vehicle includes a high-voltage load that receives a high voltage from a high-voltage battery to perform a first operation, a low-voltage load that receives a low voltage from a low-voltage battery to perform a second operation, and a controller that mutually organically controls an output of the high-voltage load and an output of the low-voltage load based on a control level set by a user.

According to an embodiment, the controller may decrease the output of the high-voltage load and increase the output of the low-voltage load.

According to an embodiment, the controller may decrease the output of the high-voltage load and increase the output of the low-voltage load when electric power of the high-voltage battery is stable.

According to an embodiment, the controller may decrease the output of the high-voltage load and increase the output of the low-voltage load through a curved control scheme or a step control scheme.

According to an embodiment, the high-voltage load may be an air conditioning heater, and the low-voltage load may be a seat heating wire.

According to an embodiment, the controller may not control an output of the air conditioning heater and an output of the seat heating wire when the control level set by the user is 1.

According to an embodiment, the controller may decrease an output of the air conditioning heater by a first reference value and increase an output of the seat heating wire from a first level, “L”, to a second level, “M”, when the control level set by the user is 2.

According to an embodiment, the controller may decrease an output of the air conditioning heater by a second reference value and increase an output of the seat heating wire from a first level, “L”, to a third level, “H”, when the control level set by the user is 3.

According to an embodiment, the controller may decrease an output of the air conditioning heater and increase an output of the seat heating wire when electric power of the high-voltage battery is stable.

According to an embodiment, the controller may decrease an output of the air conditioning heater and increase an output of the seat heating wire through a curved control scheme or a step control scheme.

According to an aspect of the present disclosure, a method for controlling electrical loads of a vehicle includes receiving, by a high-voltage load, a high voltage from a high-voltage battery to perform a first operation, receiving, by a low-voltage load, a low voltage from a low-voltage battery to perform a second operation, and mutually organically controlling, by a controller, an output of the high-voltage load and an output of the low-voltage load based on a control level set by a user.

According to an embodiment, the mutually organically controlling may include decreasing the output of the high-voltage load, and increasing the output of the low-voltage load.

According to an embodiment, the mutually organically controlling may include decreasing the output of the high-voltage load and increasing the output of the low-voltage load when electric power of the high-voltage battery is stable.

According to an embodiment, the mutually organically controlling may include decreasing the output of the high-voltage load and increasing the output of the low-voltage load through a curved control scheme or a step control scheme.

According to an embodiments, the high-voltage load may be an air conditioning heater, and the low-voltage load may be a seat heating wire.

According to an embodiment, the mutually organically controlling may exclude control of an output of the air conditioning heater and an output of the seat heating wire when the control level set by the user is 1.

According to an embodiment, the mutually organically controlling may include decreasing an output of the air conditioning heater by a first reference value and increasing an output of the seat heating wire from a first level, “L”, to a second level, “M”, when the control level set by the user is 2.

According to an embodiment, the mutually organically controlling may include decreasing an output of the air conditioning heater by a second reference value and increasing an output of the seat heating wire from a first level, “L”, to a third level, “H”, when the control level set by the user is 3.

According to an embodiment, the mutually organically controlling may include decreasing an output of the air conditioning heater and increasing an output of the seat heating wire when electric power of the high-voltage battery is stable.

According to an embodiment, the mutually organically controlling may include decreasing an output of the air conditioning heater and increasing an output of the seat heating wire through a curved control scheme or a step control scheme.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram of a system for controlling electrical loads of a vehicle according to an embodiment of the present disclosure;

FIG. 2 is an exemplary view of an air conditioning heater and a seat heating wire provided in a system for controlling electrical loads of a vehicle according to an embodiment of the present disclosure;

FIG. 3 is a diagram of an apparatus for controlling electrical loads of a vehicle according to an embodiment of the present disclosure;

FIG. 4 is an exemplary view of a performance of an apparatus for controlling electrical loads of a vehicle according to an embodiment of the present disclosure;

FIG. 5 is an exemplary view of a scheme of controlling, by a controller, an output of a high-voltage load and an output of a low-voltage load, where the controller is provided in an apparatus of controlling electrical loads of a vehicle according to an embodiment of the present disclosure;

FIG. 6 is a flowchart of a method for controlling electrical loads of a vehicle according to an embodiment of the present disclosure; and

FIG. 7 is a block diagram illustrating a computing system for executing a method for controlling electrical loads of a vehicle according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions may not be provided in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

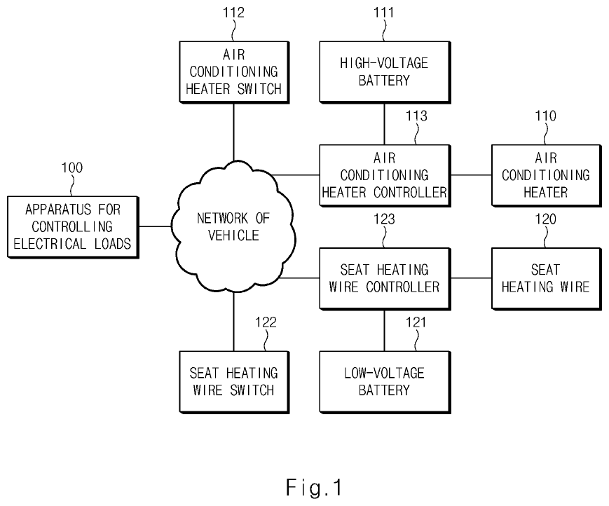

FIG. 1 is a diagram of a system for controlling electrical loads of a vehicle according to an embodiment of the present disclosure, and an air conditioning heater 110 is an example of a high-voltage load and a seat heating wire 120 is an example of a low-voltage load.

As illustrated in FIG. 1, the system for controlling electrical loads of a vehicle according to the embodiment of the present disclosure may include an apparatus 100 for controlling electrical loads, the air conditioning heater 110, a high-voltage battery 111, an air conditioning heater switch 112, an air conditioning heater controller 113, the seat heating wire 120, a low-voltage battery 121, a seat heating wire switch 122, and a seat heating wire controller 123. For example, “high-voltage” or “high voltage” may refer to a voltage (e.g., 380 V) that is higher than, for example, “low-voltage” or “low voltage,” which, for example, may be 12 V.

The apparatus 100 for controlling electrical loads is a core element of the present disclosure and may interwork with the air conditioning heater controller 113 and the seat heating wire controller 123 to mutually organically control an output of the air conditioning heater 110 and an output of the seat heating wire 120. As an example, the apparatus 100 for controlling electrical loads may increase an allowable travel distance of an electric vehicle by controlling the air conditioning heater controller 113 and the seat heating wire controller 123 to decrease the output of the air conditioning heater 110 and to increase of the output of the seat heating wire 120. Here, an output refers to an intensity, and a description that the output increase from stage 1 to stage 2 means that more electric power of the high-voltage battery 111 is consumed. The output may be determined by a pulse width modulation (PWM) duty ratio.

The apparatus 100 for controlling electrical loads may control the output of the air conditioning heater 110 and the output of the seat heating wire 120 based on a level set by a user. As an example, level 1 corresponds to a case, in which the output of the high-voltage battery 111 is unstable or the user does not set fuel ratio to be improved, and the apparatus 100 for controlling electrical loads does not control the air conditioning heater controller 113 and the seat heating wire controller 123. Then, the air conditioning heater controller 113 operates the air conditioning heater 110 based on a temperature set by the air conditioning heater switch 112, and the seat heating wire controller 123 operates the seat heating wire 120 based on a value (ON/OFF) set by the seat heating wire switch 122. Level 2 corresponds to a case, in which the user sets the fuel ratio to be improved by a low degree (e.g., 5%), and the apparatus 100 for controlling electrical loads interworks with the air conditioning heater controller 113 to decrease the output of the air conditioning heater 110 by a first reference value (for example, 20%), and interworks with the seat heating wire controller 123 to increase the output of the seat heating wire 120 from a first level, e.g., a low level (“L”), to a second level, e.g., middle level (“M”). Level 3 corresponds to a case, in which the user sets the fuel ratio to be improved by a high degree (e.g., more than 5%), and the apparatus 100 for controlling electrical loads interworks with the air conditioning heater controller 113 to decrease the output of the air conditioning heater 110 by a second reference value (for example, 40%), and interworks with the seat heating wire controller 123 to increase the output of the seat heating wire 120 from a first level, e.g., a low level (“L”), to a third level, e.g., a high level (“H”).

The apparatus 100 for controlling electrical loads may be connected to the air conditioning heater controller 113 and the seat heating wire controller 123 through a network of the vehicle. Then, the apparatus 100 for controlling electrical loads may be connected to the air conditioning heater controller 113 through a controller area network with a flexible data-rate (CAN FD), and the apparatus 100 for controlling electrical loads may be connected to the seat heating wire controller 123 through a high-speed controller area network (CAN).

In relation to an operation of the apparatus 100 for controlling electrical loads, which has been discussed above, the number of the levels has been described to help understanding and may be arbitrarily changed according to an intention of a designer.

The air conditioning heater 110 may increase a temperature of an interior of the electric vehicle by increasing a temperature of air and discharging the air into the interior of the electric vehicle.

The high-voltage battery 111 may supply a high voltage to a high-voltage load (for example, the air conditioning heater 110) provided in the electric vehicle.

The air conditioning heater switch 112 is a manual switch that is operated through an on/off operation of the user, and an air conditioning temperature may be set by the user. Then, the air conditioning heater switch 112 may be connected to the air conditioning heater controller 113 through a local interconnect network (LIN).

The air conditioning heater controller 113 is a module that controls an operation of the air conditioning heater 110, and operates the air conditioning heater 110 based on a temperature set by the air conditioning heater switch 112 at level 1. Then, the air conditioning heater controller 113 may control the output of the air conditioning heater 110 to 70%.

The air conditioning heater controller 113 may decrease the output of the air conditioning heater 110 to a first level value (for example, 20%) at level 2 and decrease the output of the air conditioning heater 110 by a second reference value (for example, 40%) at level 3, under the control of the apparatus 100 for controlling electrical loads.

The seat heating wire 120 is a heating wire located in a seat cushion and a seatback, and may directly transfer heat to the hips and the back of the user.

The low-voltage battery 121 may supply a low voltage to the low-voltage load (for example, the seat heating wire 120) provided in the electric vehicle.

The seat heating wire switch 122 is a manual switch that is operated through an on/off operation of the user, and an on/off selection may be set by the user. Then, the seat heating wire switch 122 may be connected to the seat heating wire controller 123 through the local interconnect network (LIN).

The seat heating wire controller 123 is a module that controls an operation of the seat heating wire 120, and operates the seat heating wire 120 based on a value (ON/OFF) set by the seat heating wire switch 122 at level 1.

The seat heating wire controller 123 may increase the output of the seat heating wire 120 from the low level (“L”) to the middle level (“M”) at level 2 and increases the output of the seat heating wire 120 from the low level (“L”) to the high level (“H”) at level 3, under the control of the apparatus 100 for controlling electrical loads.

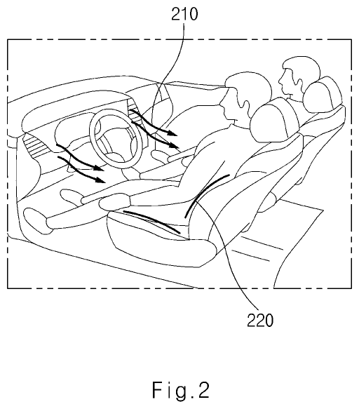

FIG. 2 is an exemplary view of an air conditioning heater and a seat heating wire provided in a system for controlling electrical loads of a vehicle according to an embodiment of the present disclosure.

As illustrated in FIG. 2, the air conditioning heater 110 is an air-heating type heater that heats air and discharges the heated air through a vent hole provided in a dashboard of the vehicle, and efficiency deteriorates because thermal energy is transferred to the user through a medium (air). For example, the output of the air conditioning heater 110 is 6.3 kW.

In contrast, the seat heating wire 120 is a contact type heater, and thermal efficiency is very high because the thermal energy is directly transferred to the user. For example, the output of the seat heating wire 120 is 0.15 kW.

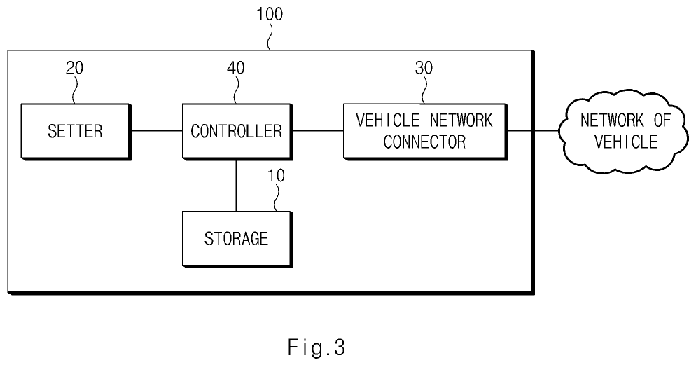

FIG. 3 is a diagram of an apparatus for controlling electrical loads of a vehicle according to an embodiment of the present disclosure.

As illustrated in FIG. 3, the apparatus 100 for controlling electrical loads of a vehicle according to the embodiment of the present disclosure may include a storage 10, a setter 20, a vehicle network connector 30, and a controller 40. The constituent elements may be coupled to each other to be implemented as a single body or some of the constituent elements may be omitted depending on a scheme of carrying out the apparatus 100 for controlling electrical loads of a vehicle according to the embodiment of the present disclosure.

In a description of the constituent elements, first, the storage 10 may store various logics, algorithms, and programs that are necessary in a process of mutually organically controlling the output of the high-voltage load and the output of the low-voltage load provided in the electric vehicle.

The storage 10 may store a table, in which control degrees of the air conditioning heater 110 and the seat heating wire 120 are recorded based on a level set by the user. Then, for example, the table is as in Table 1 as follows.

TABLE 1

| Categories | Level 1 | Level 2 | Level 3 |
|---|---|---|---|
| Air conditioning | 70% | 50% | 30% |
| heater | | | |
| Seat heating wire | L | M | H |
| Fuel ratio | No change | Fuel ratio is | Fuel ratio is |
| | | increased at | increased at |
| | | low level | high level |

In Table 1, because the change in the output of the air conditioning heater 110 is much larger than the change in the output of the seat heating wire 120, the entire output decreases consequently. The decreased output may be used to increase an allowable travel distance of the electric vehicle.

The storage 10 may store the control level (the level of Table 1) set by the user through the setter 20.

The storage 10 may include a memory, such as a flash memory type, a hard disk type, a micro type, or a card type (for example, a secure digital (SD) card or an eXtream digital (XD) card), and a storage medium of at least one of memories, such as a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The setter 20 is a module, through which a control level is set by the user, and may be implemented by an input/output device.

The vehicle network connector 30 is a module that provides a connection interface with the network of the vehicle, and the controller 40 may access the network of the vehicle through the vehicle network connector and communicate with the high-voltage load controller (for example, the air conditioning heater controller 113) and the low-voltage load controller (for example, the seat heating wire controller 123). Here, the network of the vehicle may include a controller area network (CAN), a controller area network with flexible data-rate (CAN FD), a local interconnect network (LIN), FlexRay, media oriented systems transport (MOST), and Ethernet.

The controller 40 may perform an overall control such that the elements may normally perform their functions. The controller 40 may be implemented in a form of hardware, may be implemented in a form of software, or may be implemented in a form of a combination of hardware and software. Preferably, the controller 40 may be implemented by a microprocessor, but the present disclosure is not limited thereto.

In particular, the controller 40 may perform various controls in the process of mutually organically controlling the output of the high-voltage load and the output of the low-voltage load provided in the electric vehicle. That is, the controller 40 may control the output of the air conditioning heater 110 and the output of the seat heating wire 120 while associating them with each other.

The controller 40 may detect a control value corresponding to the level set by the user through the setter 20 from the table stored in the storage 10, and may mutually organically control the output of the high-voltage load and the output of the low-voltage load based on the detected control value.

The controller 40 does not control the output of the high-voltage load and the output of the low-voltage load when the level set by the user is 1.

When the level set by the user is level 2, and the controller 40 may interwork with the air conditioning heater controller 113 to decrease the output of the air conditioning heater 110 by the first reference value (for example, 20%), and interwork with the seat heating wire controller 123 to increase the output of the seat heating wire 120 from the low level (“L”) to the middle level (“M”).

When the level set by the user is level 3, and the controller 40 may interwork with the air conditioning heater controller 113 to decrease the output of the air conditioning heater 110 by the second reference value (for example, 40%), and interwork with the seat heating wire controller 123 to increase the output of the seat heating wire 120 from the low level (“L”) to the high level (“H”).

It is preferable that the controller 40 controls the output of the air conditioning heater 110 and the output of the seat heating wire 120 when the electric power of the high-voltage battery 111 is stable (e.g., the electric power of the high-voltage battery 111 may be continuous and/or may have a voltage fluctuation of ±5%). But the controller 40 may control the output of the air conditioning heater 110 and the output of the seat heating wire 120 even when the electric power of the high-voltage battery 111 is unstable.

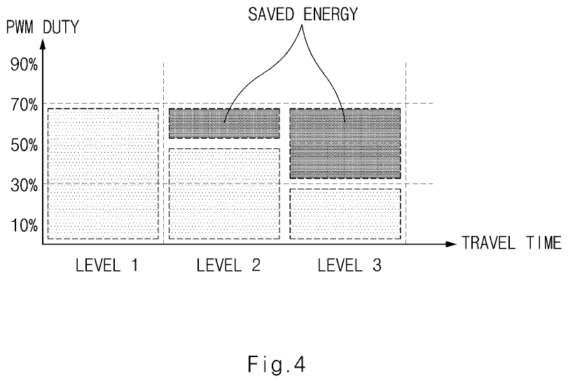

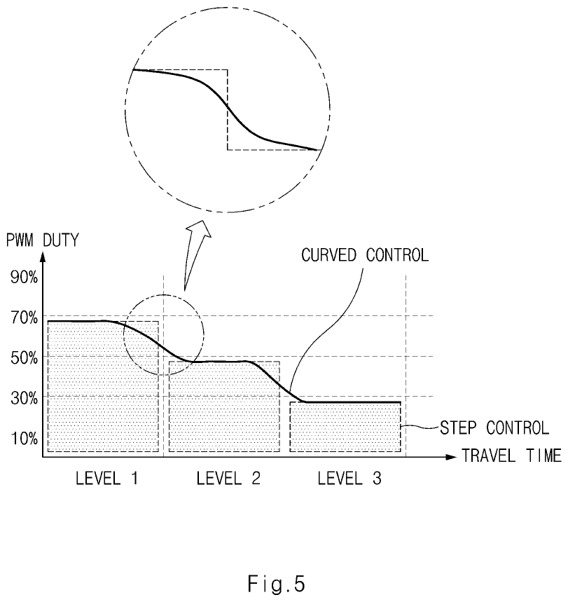

Hereinafter, an operation of the controller 40 will be discussed in detail with reference to FIGS. 4 and 5.

FIG. 4 is an exemplary view of a performance of an apparatus for controlling electrical loads of a vehicle according to an embodiment of the present disclosure.

In FIG. 4, a longitudinal axis represents a PWM duty and a transverse axis represents a travel time of the electric vehicle. Because the controller 40 does not control the output of the air conditioning heater 110 and the output of the seat heating wire 120 at level 1, the fuel ratio of the electric vehicle does not increase.

Because the controller 40 controls the output of the air conditioning heater 110 and the output of the seat heating wire 120 to low degrees at level 2, energy may be saved by about 20%, and thus the fuel ratio of the electric vehicle may increase by a degree corresponding to the saved energy. Then, the output of the air conditioning heater 110 decreases but the output of the seat heating wire 120 increases so that a sensible temperature of the user does not change.

Because the controller 40 controls the output of the air conditioning heater 110 and the output of the seat heating wire 120 to high degrees at level 3, energy may be saved by about 40%, and thus the fuel ratio of the electric vehicle may increase by a degree corresponding to the saved energy. Then, the output of the air conditioning heater 110 decreases but the output of the seat heating wire 120 increases so that a sensible temperature of the user does not change.

FIG. 5 is an exemplary view of a scheme of controlling, by a controller, an output of a high-voltage load and an output of a low-voltage load, where the controller is provided in an apparatus of controlling electrical loads of a vehicle according to an embodiment of the present disclosure.

As illustrated in FIG. 5, the controller 40 may selectively perform a curved control or a step control in a process of interworking with the air conditioning heater controller 113 to control the output of the air conditioning heater 110 and a process of interworking with the seat heating wire controller 123 to control the output of the seat heating wire 120. Then, because the curved control alleviates a rapid change in the output of the load as compared with the step control, it is usefully applied when the user may feel the load sensitively or when the difference of the output of the load is small (e.g., from level 1 to level 2 and vice versa, or from level 2 to level 3 and vice versa). However, the amount of saved energy according to the step control and the amount of saved energy according to the curved control are the same.

The controller 40 may perform the curved control on a load, on which the PWM duty control may be made, and may perform the step control on a load that is operated by a fixed output value.

Here, the curved control means smoothly controlling the output of the air conditioning heater 110 and the output of the seat heating wire 120 when level 1 is changed to level 2. For example, when the curved control is performed, the output of the seat heating wire 120 may be adjusted to “L,” “M,” and/or “H,” (depending on the level selected by the user) over a period of, for example, 5 seconds or more. The step control means rapidly controlling the output of the air conditioning heater 110 and the output of the seat heating wire 120 when level 1 is changed to level 2. For example, when the step control is performed, the output of the seat heating wire 120 may be adjusted to “L,” “M,” and/or “H,” (depending on the level selected by the user) over a period of, for example, less than 5 seconds.

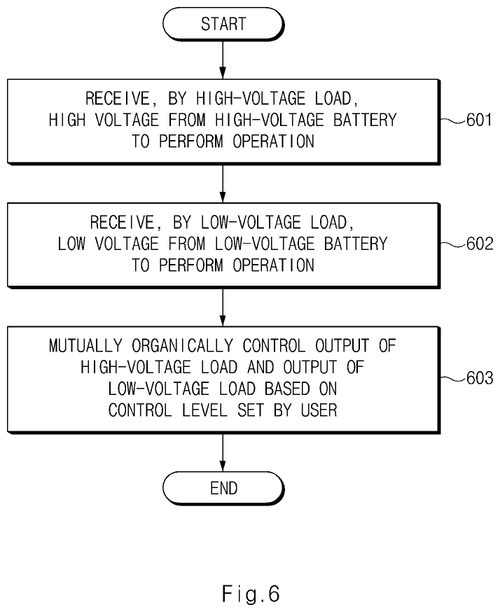

FIG. 6 is a flowchart of a method for controlling electrical loads of a vehicle according to an embodiment of the present disclosure.

First, the high-voltage load receives a high voltage from the high-voltage battery 111 to perform an operation thereof (601) (e.g., a first operation).

Furthermore, the low-voltage load receives a low voltage from the low-voltage battery 121 to perform an operation thereof (602) (e.g., a second operation).

Thereafter, the controller 40 mutually organically controls the output of the high-voltage load and the output of the low-voltage load based on a control level set by the user.

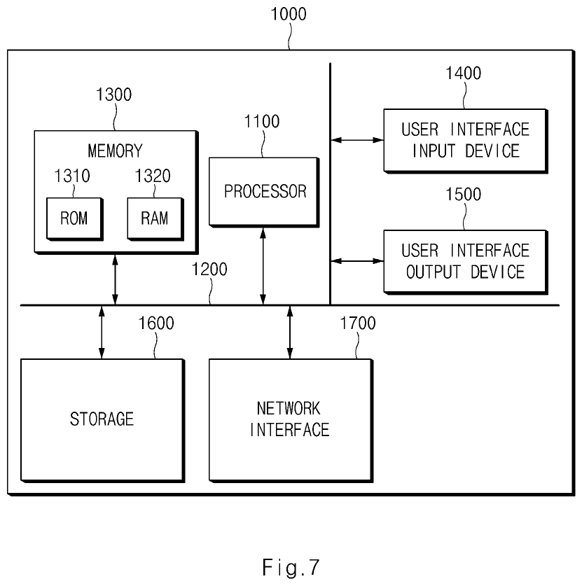

FIG. 7 is a block diagram illustrating a computing system for executing a method for controlling electrical loads of a vehicle according to an embodiment of the present disclosure.

Referring to FIG. 7, the method for controlling electrical loads of a vehicle according to the embodiment of the present disclosure also may be implemented through a computing system. The computing system 1000 may include at least one processor 1100, a memory 1300, a user interface input device 1400, a user interface output device 1500, a storage 1600, and a network interface 1700 connected through a system bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the steps of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, a solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

In the apparatus and the method for controlling electrical loads of a vehicle according to the embodiments of the present disclosure, an allowable travel distance of an electric vehicle may be increased while a requirement (an increase in a sensible temperature) of a user is satisfied, by mutually organically controlling an output of a high-voltage load provided in the electric vehicle and an output of a low-voltage load provided in the electric vehicle.

The above description is a simple exemplification of the technical spirits of the present disclosure, and the present disclosure may be variously corrected and modified by those skilled in the art to which the present disclosure pertains without departing from the essential features of the present disclosure.

Accordingly, the embodiments disclosed in the present disclosure is not provided to limit the technical spirits of the present disclosure but provided to describe the present disclosure, and the scope of the technical spirits of the present disclosure is not limited by the embodiments. Accordingly, the technical scope of the present disclosure should be construed by the attached claims, and all the technical spirits within the equivalent ranges fall within the scope of the present disclosure.

What is claimed is:

1. An apparatus for controlling electrical loads of a vehicle, the apparatus comprising:
a high-voltage load to receive a high voltage from a high-voltage battery to perform a first operation;
a low-voltage load to receive a low voltage from a low-voltage battery to perform a second operation; and
a controller to mutually organically control an output of the high-voltage load and an output of the low-voltage load based on a control level set by a user.

2. The apparatus of claim 1, wherein the controller is to decrease the output of the high-voltage load and increase the output of the low-voltage load.

3. The apparatus of claim 1, wherein the controller is to decrease the output of the high-voltage load and increase the output of the low-voltage load when electric power of the high-voltage battery is stable.

4. The apparatus of claim 1, wherein the controller is to decrease the output of the high-voltage load and increase the output of the low-voltage load through a curved control scheme or a step control scheme.

5. The apparatus of claim 1, wherein the high-voltage load is an air conditioning heater, and wherein the low-voltage load is a seat heating wire.

6. The apparatus of claim 5, wherein the controller does not control an output of the air conditioning heater and an output of the seat heating wire when the control level set by the user is 1.

7. The apparatus of claim 5, wherein the controller is to decrease an output of the air conditioning heater by a first reference value and increase an output of the seat heating wire from a first level, “L”, to a second level, “M”, when the control level set by the user is 2.

8. The apparatus of claim 5, wherein the controller is to decrease an output of the air conditioning heater by a second reference value and increases an output of the seat heating wire from a first level, “L”, to a third level, “H”, when the control level set by the user is 3.

9. The apparatus of claim 5, wherein the controller is to decrease an output of the air conditioning heater and increase an output of the seat heating wire when electric power of the high-voltage battery is stable.

10. The apparatus of claim 5, wherein the controller is to decrease an output of the air conditioning heater and increase an output of the seat heating wire through a curved control scheme or a step control scheme.

11. A method for controlling electrical loads of a vehicle, the method comprising:
receiving, by a high-voltage load, a high voltage from a high-voltage battery to perform a first operation;
receiving, by a low-voltage load, a low voltage from a low-voltage battery to perform a second operation; and
mutually organically controlling, by a controller, an output of the high-voltage load and an output of the low-voltage load based on a control level set by a user.

12. The method of claim 11, wherein the mutually organically controlling includes:
decreasing the output of the high-voltage load; and
increasing the output of the low-voltage load.

13. The method of claim 11, wherein the mutually organically controlling includes:
decreasing the output of the high-voltage load and increasing the output of the low-voltage load when electric power of the high-voltage battery is stable.

14. The method of claim 11, wherein the mutually organically controlling includes:
decreasing the output of the high-voltage load and increasing the output of the low-voltage load through a curved control scheme or a step control scheme.

15. The method of claim 11, wherein the high-voltage load is an air conditioning heater, and
wherein the low-voltage load is a seat heating wire.

16. The method of claim 15, wherein the mutually organically controlling
excludes control of an output of the air conditioning heater and an output of the seat heating wire when the control level set by the user is 1.

17. The method of claim 15, wherein the mutually organically controlling includes:
decreasing an output of the air conditioning heater by a first reference value and increasing an output of the seat heating wire from a first level, “L”, to a second level, “M”, when the control level set by the user is 2.

18. The method of claim 15, wherein the mutually organically controlling includes:
decreasing an output of the air conditioning heater by a second reference value and increasing an output of the seat heating wire from a first level, “L”, to a third level, “H”, when the control level set by the user is 3.

19. The method of claim 15, wherein the mutually organically controlling includes:
decreasing an output of the air conditioning heater and increasing an output of the seat heating wire when electric power of the high-voltage battery is stable.

20. The method of claim 15, wherein the mutually organically controlling includes:
decreasing an output of the air conditioning heater and increasing an output of the seat heating wire through a curved control scheme or a step control scheme.
